(19) United States
(12) Patent Application Publication
(10) Pub. No.: US 2003/0066046 A1
(43) Pub. Date: Apr. 3, 2003

(54) Java virtual machine with non-volatile memory

(76) Inventor: Thomas Patrick Dawson, Escondido, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/112,395

(22) Filed: Mar. 29, 2002

Related U.S. Application Data
(60) Provisional application No. 60/318,035, filed on Sep. 7, 2001.

(51) Int. Cl. G06F 7/00

(52) U.S. Cl. 717/100

(57) ABSTRACT

In a Java Virtual Machine in which information is gathered about what sections of code get used most frequently in an embedded application. This information comprises binary data which is saved into non-volatile random access memory (RAM). The binary data is compressed for storage. At a subsequent startup, the stored compressed data is retrieved and decompressed and written to a volatile memory.

### CROSS-REFERENCE TO RELATED APPLICATION

This application claims benefit of the priority of U.S. Provisional Application No. 60/318,035, filed Sep. 7, 2001 and entitled “Embedded Java Virtual Machine.”

### FIELD OF INVENTION

The present invention relates to a data processing system and method, and more particularly to improving performance and execution of Java programs.

### BACKGROUND OF THE INVENTION

The present invention provides particular utility in embedded systems, although it is applicable to other systems as well. Embedded systems generally comprise processors placed in an environment for a particular use, for example, process control, as opposed to being provided in a desk top computer to be available for virtually any application which can be hosted on that computer. Generally, an embedded computer is utilized for a narrow range of applications. To use Java code, embedded systems will include a Java Virtual Machine (JVM). A JVM translates Java program code, referred to as byte code, into instructions for a device. The JVM may be implemented either as a software structure or it may be implemented in hardware as an ASIC or FPGA. Java itself is platform independent. The Java commands are translated into native code.

Originally, the JVM was a command interpreter. Each line of Java code would have to be decoded and run independently. Consequently, Java programs would run more slowly than compiled C or C++ code. A more recent technique to speed Java processing is just-in-time (JIT) compiling. Frequently used small sections of Java code are compiled and saved in a random access memory (RAM). When the frequently used section is encountered, it is accessed from the RAM rather than being recompiled. A number of prior art arrangements exist for characterizing parts of code that are being run most frequently.

In the general purpose personal computer (PC) environment, there is no motivation to store the permanent compiled sections permanently. There is usually a constant variety of applications being run. However, in an embedded environment, generally, a limited number of functions are being performed. For example, it may be desirable to run one routine such as on-screen display. Using the prior art, it would be necessary to characterize the most frequently run routines each time upon start-up. It is impractical to perform this function for general purpose computers due to the extremely wide range of applications that may be encountered.

This problem has been approached by providing a Java Virtual Machine in which information is gathered about what sections of code get used most frequently in an embedded application. This information is saved into non-volatile random access memory (RAM). When a Java Virtual Machine is started, it loads its particular application, for example, on-screen display, and the characterization information from the non-volatile RAM. Native code is compiled, and full-speed operation is provided from the outset of operation.

The kind of non-volatile memory used to store this data is very expensive. It is desirable to reduce the memory footprint required in embedded systems in particular. Embedded systems may, for example, be embodied in mass produced items such as appliances, where price is a critically important factor. It is also desirable to provide maximum capacity for a given amount of memory.

### SUMMARY OF THE INVENTION

In a Java Virtual Machine in which information is gathered about what sections of code get used most frequently in an embedded application. This information comprises binary data which is saved into non-volatile random access memory (RAM). The binary data is compressed for storage. At a subsequent startup, the stored compressed data is retrieved and decompressed and written to a volatile memory.

### BRIEF DESCRIPTION OF THE DRAWINGS

The invention may be further understood by reference to the following description taken in connection with the following drawings:

Of the drawings:

FIG. 1 is an illustration of a typical software stack for an embedded application;

FIG. 2 is a block diagram of a Java processor operating in the context of FIG. 1.

FIG. 3 is flow chart of the prior art technique for identifying frequently used code sections;

FIG. 4 is an illustration of a program having typical user scenarios; and

FIG. 5 is a flow diagram illustrating operation of the present invention.

### DETAILED DESCRIPTION

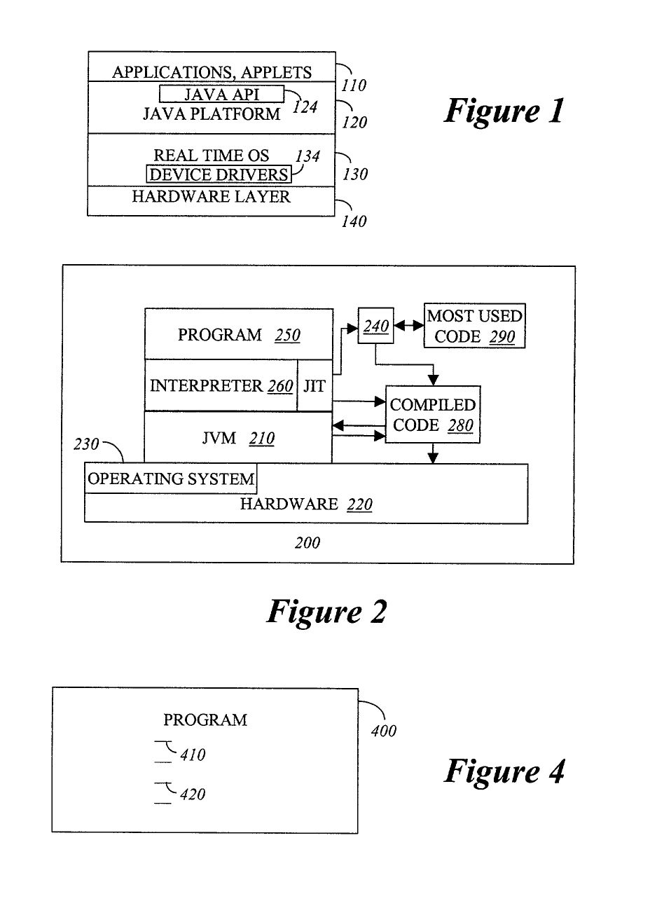

FIG. 1 illustrates a typical software stack for an embedded application and describes the hardware and software environment for the Java environment. The Java stack 100 includes an application layer 110 including applications and platforms. The application layer 110 interfaces with a Java technology layer 120. The Java technology layer 120 includes a Java application program interface 124. Applications developed for the embedded systems can use the Java application program interface and Java class libraries in the Java platform. The Java technology layer 120 interfaces with a real-time operating system 130, which includes device drivers 134. The real-time operating system layer 130. As used in this description, the term operating system includes device drivers. The Java application program interface 124 operates within the hardware context of the embedded system. In the example in which a display is being driven, a central feature is a data pipeline. The application program interface 124 provides an abstraction that allows the application programmer to remain unaware of the details of the underlying display hardware environment.

FIG. 2 is a block diagram of a client computer, or processor, 200 embodying a Java Virtual Machine 210. Note that in this embodiment the Java Virtual Machine is a software structure and embodied with the memory of the client computer 200. Within the computer 200, computer hardware 220 is controlled by the operating system 230. The Java Virtual Machine 210's operations are implemented on the operating system 230 and computer hardware 220. The Java Virtual Machine 210 executes a program 250 loaded into the computer system 200 or otherwise accessed thereby. Java programming normally comprises class files. A Java interpreter 260 interprets Java byte codes one by one. A just-in-time (JIT) Java compiler 270 produces native code to be run on the computer hardware 220 and provides compiled code in a compiled code register 280. The compiled code register 280 provides object code for operations called by the Java Virtual Machine 210 to the computer hardware 220.

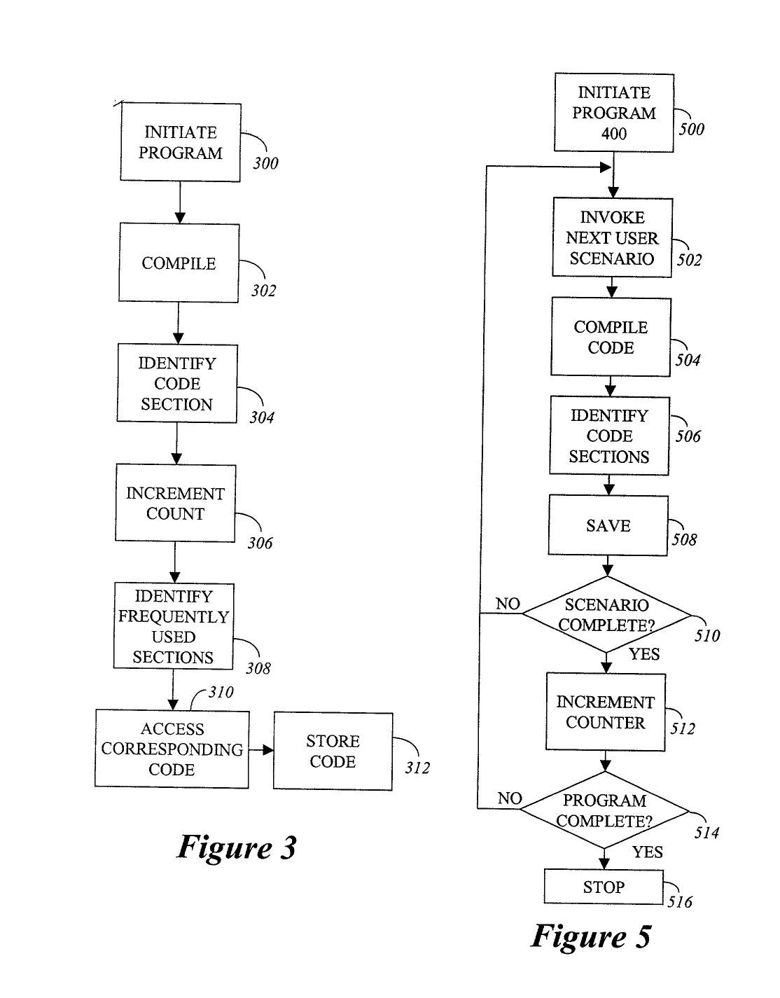

The program 250 also comprises software to perform the method of FIG. 3 below and command supplying of code to a compressor/decompressor 240 indicative of instructions identified by the operation of the method explained with respect to FIG. 3 below. Code representative of the most used software sections is compressed and stored in a code memory 290. The code memory 290 comprises non-volatile RAM. Preferably the code supplied to the code memory 290 is compiled code. This compiled code is supplied for decompression via the compressor/decompressor to the compiled code register 280 on machine startup. Since code memory 290 is expensive, compression will decrease memory requirements and reduce the price of many embodiments. It is desirable that the compression and decompression be lossless so that code is not corrupted. The means which may comprise particular elements of the compression and decompression processing are well-known in the art. Varied means of compression and decompression without loss of data are available for this purpose.

Operation is described with respect to FIG. 3, which is a flow diagram. Operation begins at block 300, at which time execution of the program 250 is initiated. Since the memory 280 is volatile, compiling must begin each time operation is initiated. Compiling is indicated at block 302. At block 304, the identity of a current code section is sensed. A code section is a particular line of code or Java class that is compiled. At block 306, a code section count is incremented for each section of code identified at block 304. At block 308, frequently used sections of compiled code are identified. “Frequently” is defined by a pre-selected threshold count reached over a preselected time period.

Once frequently used code sections are identified, code indicative thereof is accessed. The accessed code is preferably compiled. The code is compressed at the compressor/decompressor 240 and written to the code memory 290 at block 312, may be invoked from the memory 280 (FIG. 2).

FIG. 4 is an illustration of an abbreviated source code listing for an embedded program. For purposes of the present example, the embedded program is running an on-screen display. Routines 410 are functions performed by the program 400. Different routines 410 can be selected based on knowledge of programming of the application which will be the most used functions of the program 400. The particular ones of the routines 410 that are selected as the most typical functions invoked by users are called for purposes of the present description typical user scenarios 420.

FIG. 5 is a flow diagram illustrating further operation and structure of the present invention. At block 500, the program 400 is initiated. At block 502, the first typical user scenario 420 is invoked. At block 504, code sections that are utilized are identified. At block 504, code is compiled. At block 506, code sections invoked are identified. Frequently used sections are saved at block 508. At block 510, a determination is made as to whether a user scenario 420 is complete. Such determination is made by comparing the actual list of methods called in the user-invoked scenario to the total list of methods therein. If the user scenario is complete, then operation returns to block 502 to invoke a next user scenario, at the same time, a routine counter 512 is incremented. At block 514, a determination is made as whether all user-invoked scenarios have been invoked and when they have, the program is stopped at block 516. The invention does not require that all scenarios have to be converted to native code.

In operation of FIG. 5, in addition, at block 508 the compiled code is compressed saved to non-volatile memory 290 (FIG. 2). When the Java Virtual Machine 210 (FIG. 2) is started again, it loads its on-screen display application 400, which will constitute the program 250 in FIG. 2, and will have available characterization information from the non-volatile RAM 290. The frequently used sections which are invoked in response to typical user scenarios 420 (FIG. 4) are decompressed and loaded immediately in the compiled Java code register 280. Consequently the computer system 200 operates at full speed from the outset. The computer system 200 of FIG. 2 also represents a delivered product in which characterization information is loaded into the non-volatile RAM 290 prior to operation. Consequently, a computer product is provided which will operate on the program 400 at full speed from beginning of its operation.

The above disclosure will enable those skilled in the art to provide a method, machine-readable medium and apparatus constructed in accordance with the present invention even while making many departures from the specific teachings above.

What is claimed is:

1. A Java virtual machine comprising interface to a program, the program having defined therefore typical user scenarios, each user scenario having associated therewith most frequently used code sections; said Java virtual machine being connected for receiving identifies of most frequently used code sections, accessing code corresponding to the most frequently used code sections, compressing the code and writing the code to a non-volatile memory.

2. The Java virtual machine according to claim 1 wherein said Java Virtual Machine at a subsequent initiation of operation further accesses code from said non-volatile memory and decompresses the code.

3. The Java virtual machine of claim 2 wherein the Java Virtual Machine loads a volatile memory with decompressed code

4. The Java virtual machine according to claim 2 wherein said Java virtual machine utilizes lossless compression and decompression.

5. A method for determining most frequently used sections of codes comprising providing a program to perform pre-selected tasks;
said pre-selected tasks having associated therewith typical user scenarios;
programming a Java virtual machine to run said typical user scenarios;
identifying code sections called in response to invoking said typical user scenarios, identifying said code sections and saving identities thereof, accessing code corresponding to the saved identities, compressing the code and saving the compressed code and continuing said operation until a pre-selected group of typical user scenarios have been invoked by said Java Virtual Machine.

6. The method according to claim 5 wherein at least one said user scenario comprises a plurality of classes and invoking said scenario comprises running each class.

7. The method according to claim 6 wherein the step of saving the compressed code comprises writing to a non-volatile RAM.

8. The method according to claim 7 further comprising at a subsequent startup accessing compressed code from the non-volatile memory, decompressing the code and writing decompressed code to a volatile memory.

9. The Java virtual machine according to claim 7 wherein said compression and decompression comprise lossless compression and decompression.

10. A Java processor comprising an interpreter and compiler for running a program, the program having associated therewith typical user scenarios; means for counting code sections executed in performance of a program and identifying most-used code sections, means for accessing code corresponding to each said most-used section, a non-volatile memory, and compression means for compressing the code and writing the code to a non-volatile memory.

11. The processor according to claim 10 wherein said means for accessing accesses compiled code.

12. The processor of claim 11 further comprising decompression means for decompressing said code stored in said non-volatile memory, a volatile code memory and means for writing decompressed code to the volatile memory in response to initiation of operation of said processor.

13. The processor according to claim 12 wherein said means for compression and decompression comprise means for lossless compression and decompression respectively.
